(19) United States
(12) Patent Application Publication
(10) Pub. No.: US 2026/0337856 A1
(43) Pub. Date: Oct. 29, 2026

(54) LAUNDRY TREATING APPARATUS

(71) Applicant: LG ELECTRONICS INC., Seoul (KR)

(72) Inventor: Kyunghye SEO, Seoul (KR)

(21) Appl. No.: 19/110,747

(22) PCT Filed: Sep. 13, 2023
(86) PCT No.: PCT/KR2023/013697

§ 371 Date: Mar. 11, 2025

(30) Foreign Application Priority Data
Sep. 27, 2022 (KR) 10-2022-0122826

(51) Int. Cl. D06F 34/32; G06F 3/02; G06F 3/04847; G06F 3/0488

(52) U.S. Cl. CPC D06F 34/32; G06F 3/02; G06F 3/04847; G06F 3/0488

(57) ABSTRACT

The present invention relates to a laundry treating apparatus. The laundry treating apparatus according to an embodiment of the present invention includes: a touch screen for receiving a touch input and outputting an image; and a UI part provided in an area different from that of the touch screen and including a button part for receiving an input of a user, wherein the laundry treating apparatus includes a locking function for restricting an input through the touch screen and an input through the button part, and when an input is received by touching the touch screen for a configured time or more in a state of activating the locking function, the locking function is deactivated.

### CROSS-REFERENCE TO RELATED PATENT APPLICATIONS

This application is a U.S. National Stage Application under 35 U.S.C. § 371 of PCT Application No. PCT/KR2023/013697, filed Sep. 13, 2023, which claims priority to Korean Patent Application No. 10-2022-0122826, filed Sep. 27, 2022, whose entire disclosures are hereby incorporated by reference.

### TECHNICAL FIELD

The present disclosure relates to a laundry treating apparatus for processing clothing.

### BACKGROUND ART

A laundry treating apparatus is an apparatus for performing necessary processing of the laundry, such as removing contamination from the laundry or drying the laundry, by placing the laundry, such as clothing or bedding, inside a drum.

The necessary processing of the laundry may be achieved through a course including one or more of a wash cycle, a rinse cycle, a dehydration cycle, a drying cycle, and a refresh cycle. The wash cycle is a process of separating foreign matter attached to the laundry with water and detergent. The rinse cycle is a process of separating the laundry and the foreign matter with water. The dehydration cycle is a process of removing water from the laundry. The drying cycle is a process of removing moisture from the laundry. The refresh cycle is a process of performing one or more of deodorization, wrinkle removal, and sterilization of laundry using one or more of air or steam.

When the laundry treating apparatus is arranged to remove contaminants from the laundry, the laundry treating apparatus may perform cycles such as the washing, rinsing, dehydration, and drying. The laundry treating apparatus may include a cabinet defining an exterior, a tub accommodated in the cabinet, a drum rotatably mounted inside the tub and configured to receive laundry loaded thereinto, and a detergent supply device configured to supply detergent into the drum. When the drum is rotated by a motor with wash water supplied to the laundry accommodated in the drum, dirt may be removed from the laundry by friction between the laundry and the drum and wash water.

When the laundry treating apparatus is arranged to dry the laundry, the laundry treating apparatus may provide dry air to the laundry to remove moisture from the laundry. The laundry treating apparatus may include a cabinet, a drum rotatably arranged in the cabinet, and heating means configured to heat or dry the air provided to the laundry. As dry air is provided to the laundry accommodated in the drum, moisture present in the laundry may be evaporated and removed by the dry air, and the laundry may be dried.

Korean Patent Application Publication No. 10-2022-0029635 A1 discloses a cloth treating apparatus including multiple treating apparatuses. The cloth treating apparatus of the document has a first treating apparatus arranged on the upper side and a second treating apparatus arranged on the lower side. A control panel including an operation part and a display part for controlling the first treating apparatus and the second treating apparatus is provided in the center area of the front of the cloth treating apparatus.

Recently, consumers' interest in interior design has been increasing. This interest is reflected in the trend of integrating home appliances with furniture. Home appliances, which were previously recognized as electronic devices, are now required to go beyond clunky designs with numerous control buttons and meet the increasingly refined aesthetic preferences of consumers.

### DISCLOSURE

### Technical Problem

A laundry treating apparatus is equipped with a button lock function to prevent accidents caused by children pressing buttons during the operation of the apparatus. When the button lock is set, it needs to be release the same later, and thus a lock symbol is marked on one of the control buttons to guide the user. However, the presence of various buttons and symbols required for the lock function prevent the appliance from achieving a more refined design.

An object of the present disclosure is to provide a laundry treating apparatus that provides a lock function, but allows the button for the lock function or a related shape to be removed from the basic appearance of the laundry treating apparatus.

Another object of the present disclosure is to provide a laundry treating apparatus that provides a user interface that allows any user, even those who have not read the user manual for the apparatus, to smoothly unlock the set lock.

Another object of the present disclosure is to provide a laundry treating apparatus that implements a simple user interface for a control panel capable of controlling multiple processing apparatuses constituting the laundry treating apparatus, while also enhancing the interior aesthetics when placed in an installation environment.

Another object of the present disclosure is to provide a laundry treating apparatus that allows images displayed on the user interface (UI) during the operation of a cycle and/or course to blend aesthetically into the installation space.

The objects that can be achieved with the embodiments are not limited to what has been particularly described hereinabove and other objects not mentioned herein will become apparent to those skilled in the art from the following detailed description.

### Technical Solution

In one aspect, a laundry treating apparatus is provided. In one embodiment, the laundry treating apparatus may include a user interface (UI) part including a touch screen configured to receive a touch input and display an image, and a button part provided in a different area from the touch screen to receive an input from a user, wherein the laundry treating apparatus may have a lock function to restrict inputs through the touch screen and the button part. Based on the touch input being maintained on the touch screen for a set time or longer with the lock function in an enabled state, the lock function may be disabled.

In one embodiment, based on a user input being received through the touch screen or the button part with the lock function enabled, the touch screen may output an indication that the lock function is in the enabled state.

In one embodiment, based on a user input being received through the touch screen or the button part with the lock function enabled, the touch screen may output a method to disable the lock function.

In one embodiment, the touch screen may output one of a first page indicating a processing course, and a function setting page, wherein the function setting page may contain a lock setting part, the lock setting part being configured to receive a user command to enable the lock function.

In one embodiment, the lock setting part may contain a switch configured to receive a user command to switch the lock function to the enabled state.

In one embodiment, based on the lock function being enabled on the function setting page, the output of the touch screen may switch from the function setting page to the first page.

In another aspect of the present disclosure, a laundry treating apparatus may include a user interface (UI) part including a touch screen configured to receive a touch input and display an image, and a button part provided in a different area from the touch screen to receive an input from a user, wherein the laundry treating apparatus may have a lock function to restrict inputs through the touch screen and the button part, wherein the touch screen may output one of a first page indicating a processing course, and a function setting page, wherein the function setting page may contain a lock setting part, the lock setting part being configured to receive a user command to enable the lock function.

In one embodiment, the lock setting part may contain a switch configured to receive a user command to switch the lock function to the enabled state.

In one embodiment, the lock function may be enabled on the function setting page.

In this case, the output on the touch screen may switch from the function setting page to the first page.

In one embodiment, based on a user input being received through the touch screen or the button part with the lock function enabled, the touch screen may output an indication that the lock function is in the enabled state.

In one embodiment, based on a user input being received through the touch screen or the button part with the lock function enabled, the touch screen may output a method to disable the lock function.

In one embodiment, the laundry treating apparatus may further include a first processing apparatus having a first drum arranged therein to accommodate clothing, a second processing apparatus having a second drum arranged therein to accommodate clothing, and a control panel configured to control one or both of the first processing apparatus and the second processing apparatus, the control panel including the UI part, wherein the touch screen may display one of a first apparatus operation UI configured to operate the first processing apparatus, and a second apparatus operation UI configured to operate the second processing apparatus, wherein, based on a command to enable the lock function being input on one of the first apparatus operation UI and the second apparatus operation UI, the lock function may be applied to the other one of the first apparatus operation UI and the second apparatus operation UI.

In one embodiment, the first apparatus operating UI and the second apparatus operating UI may be output on the touch screen.

In one embodiment, the first processing apparatus may include a first front panel arranged on a front side thereof, and the second processing apparatus may include a second front panel arranged on a front side thereof, wherein the control panel may be arranged between the first front panel and the second front panel.

In one embodiment, the first processing apparatus may be a washing machine, and the second processing apparatus may be a dryer. The second processing apparatus may be positioned on top of the first processing apparatus.

### Advantageous Effects

According to various embodiments, a laundry treating apparatus may eliminate various buttons and symbols required for the lock function, thereby overcoming the design limitations of home appliances and functioning as an interior element.

According to various embodiments, a laundry treating apparatus may provide a user interface that allows any user, even those who have not read the user manual for the apparatus, to smoothly unlock the set lock.

According to various embodiments, a laundry treating apparatus may implement a simple user interface for a control panel capable of controlling multiple processing apparatuses constituting the laundry treating apparatus, while also enhancing the interior aesthetics when placed in an installation environment.

According to embodiments, a laundry treating apparatus may allow images displayed on the user interface (UI) during the operation of a cycle and/or course to blend aesthetically into the installation space.

According to embodiments, a laundry treating apparatus may implement a simple user interface for a control panel capable of controlling multiple processing apparatuses constituting the laundry treating apparatus, while also enhancing the interior aesthetics when placed in an installation environment.

The effects of the present disclosure are not limited to those described above, and other effects not described will be apparent to one of ordinary skill in the art from this description and the accompanying drawings.

### DESCRIPTION OF DRAWINGS

FIG. 1 is a perspective view of a laundry treating apparatus according to one embodiment of the present disclosure.

FIG. 2 is a schematic diagram illustrating the interrelationship between a control panel, a first processing apparatus, and a second processing apparatus according to one embodiment of the present disclosure.

FIG. 3 is a front perspective view of a control panel according to one embodiment of the present disclosure.

FIG. 4 is an exploded perspective view of a control panel according to one embodiment of the present disclosure.

FIG. 5 is an exploded view of a UI part according to one embodiment of the present disclosure.

FIG. 6a shows a table listing various touch gestures for touching the touch input part according to one embodiment of the present disclosure.

FIG. 6b shows a table listing, by cause, the flows that switch images on the screen.

FIG. 7 illustrates a cycle flow according to one embodiment when a washing machine is provided as a first processing apparatus or a second processing apparatus.

FIG. 8 illustrates a cycle flow according to one embodiment when a dryer is provided as the first processing apparatus or the second processing apparatus according to one embodiment of the present disclosure.

FIG. 9 illustrates a first apparatus operation UI displayed on a touch screen according to one embodiment of the present disclosure, wherein a course selection page is output according to one embodiment.

FIG. 10 illustrates a UI part in which the first processing apparatus is powered on and the second processing apparatus is powered off according to one embodiment of the present disclosure, while a course selection page of a first apparatus operation UI is output on a touch screen.

FIG. 11 shows an additional function page of the first processing apparatus, illustrating a touch input to enter a “common settings” item among the items of the additional function.

FIG. 12 shows a common settings page, which is a page that contains a group of additional functions that may be set in common for the first processing apparatus and the second processing apparatus.

FIG. 13a (a) and (b) illustrates a first embodiment and flow of setting a lock function among the additional functions.

FIG. 13b (a) and (b) shows a second embodiment and flow of setting a lock function among the additional functions.

FIG. 14 (a) to (c) shows an image displayed on the touch screen when the lock is set and a flow for unlocking the lock.

### BEST MODE

Hereinafter, embodiments of the present disclosure will be described in detail with reference to the accompanying drawings to provide a further understanding of the present disclosure to those of ordinary skill in the art.

It will be apparent to those skilled in the art that the present disclosure can be implemented in various different forms and is not limited to the embodiments described herein. In the drawings, parts irrelevant to the description have been omitted in order to clearly describe the present disclosure. Wherever possible, the same reference numbers will be used throughout the specification to refer to the same or like parts.

In the present disclosure, redundant descriptions of the same components are generally omitted.

### DEFINITION OF TERMS

As used in the following description, the term “laundry treating apparatus” refers to any apparatus capable of processing clothing by washing, drying, or refreshing the clothing. As used herein, the term “processing apparatus” refers to any apparatus capable of processing clothing by washing or drying the clothing, but is defined as a subordinate concept of the “laundry treating apparatus.” In the embodiments shown and described, the laundry treating apparatus is an apparatus provided with a first processing apparatus and a second processing apparatus stacked on top of each other.

As used in the following description, the term “processing of clothing” refers to treatments such as washing, sterilization, bleaching, softening, and drying performed on clothing. The processing of clothing may be achieved by cycles and courses performed by the laundry treating apparatus. One or more cycles are combined to form a course. One or more cycles are arranged in chronological order and may be combined to form a course. The cycles include a wash cycle, a rinse cycle, a dehydration cycle, a cooling cycle, and a refresh cycle. The wash cycle is a process of separating foreign matter attached to the laundry with water and detergent. The rinse cycle is a process of separating the laundry and the foreign matter with water. The dehydration cycle is a process of removing water from the laundry. The drying cycle is a process of removing moisture from the laundry. The cooling cycle is a process of reducing the temperature of heated laundry. The refresh cycle is a process of performing one or more of deodorization, wrinkle removal, and sterilization of laundry using one or more of air or steam.

As used in the following description, the term “detergent” refers to any substance used to sterilize or disinfect clothing, fabrics, or the like or remove impurities therefrom. In one embodiment, the detergent may be in the form of a solid, such as a powder, or a liquid.

As used in the following description, the term “softener” refers to any substance or chemical used to soften clothing, fabrics, or the like.

As used in the following description, the term “bleach” refers to any substance or chemical that chemically decomposes and removes colored substances contained in the fabrics or the like to whiten fabrics or the like.

As used in the following description, the term “clothing processing agent” refers to any substance capable of causing a chemical or physical effect to process clothing. In one embodiment, the clothing processing agent may encompass detergent, fabric softener, and bleaches.

As used in the following description, the term “fluid” refers to any fluid that may be mixed with a clothing processing agent, or that may act as a solvent for the clothing processing agent. In one embodiment, the fluid may be wash water, i.e., water.

As used in the following description, the terms “upper side,” “lower side,” “left side,” “right side,” “front side” and “rear side” are to be understood with reference to the coordinate system in the referenced drawings.

In this specification, when a component is referred to as being “connected” or “coupled” to another component, it is to be understood that it may be directly connected or coupled to the other component, or that there may be other components in between. On the other hand, when a component is referred to in this specification as being “directly connected” or “directly coupled” to another component, it is to be understood that there are no other components in between.

The terms used in this specification are merely used to describe particular embodiments and are not intended to limit the disclosure.

As used herein, the singular forms “a,” “an,” and “the” include plural referents unless context clearly dictates otherwise.

As used herein, the terms “includes” or “has” are intended to specify the presence of the features, numbers, steps, operations, components, parts, or combinations thereof disclosed in the specification, and are not to be understood as precluding the possibility of the presence or addition of one or more other features, numbers, steps, operations, components, parts, or combinations thereof.

As used herein, the term “and/or” includes a combination of a plurality of listed items or any of the plurality of listed items. As used herein, “a or b” may include “a,” “b,” or “both a and b.”

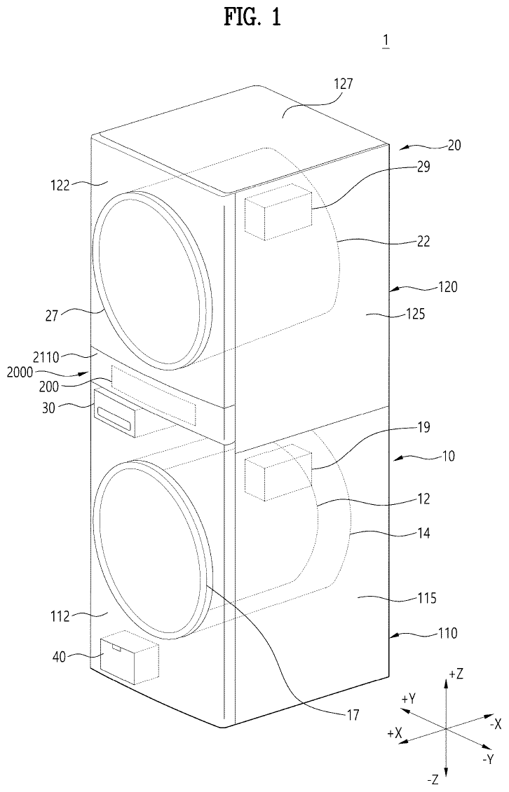

FIG. 1 shows a laundry processing apparatus 1 according to one embodiment of the present disclosure. In the embodiment, the laundry processing apparatus 1 includes a first processing apparatus 10, a second processing apparatus 20, and a control panel 2000.

In the description of the present disclosure, the terms forward direction (+X), backward direction (−X), first side direction (+Y), second side direction (−Y), upward direction (+Z), and downward direction (−Z) may be consistently defined for the respective elements. For example, the front-to-back direction (+X, −X) of the first processing apparatus 10 may be defined as the same as the front-to-back direction of the second processing apparatus 20, the control panel 2000, and the like, and the side direction (Y) and the up-down direction (Z) may be defined similarly.

The first processing apparatus 10 and the second processing apparatus 20 may be of various types for processing clothing, such as a washing machine for washing clothing and/or a dryer for drying clothing. The first processing apparatus 10 may be a washing machine and the second processing apparatus 20 may be a dryer. The first processing apparatus 10 and the second processing apparatus 20 may both be washing machines or dryers. The first processing apparatus 10 may be a dryer and the second processing apparatus 20 may be a washing machine. They may be various apparatuses for processing clothing.

In an embodiment, the first processing apparatus 10 arranged on the lower side may correspond to a washing machine for washing clothing. A first drum 12 and a tub 14 to accommodate clothing may be provided in the first processing apparatus 10. The first drum 12 in the first processing apparatus 10 may be rotatably arranged inside the tub 14. In one embodiment, the first drum 12 has a shaft arranged in the front-to-back direction (+X, −X).

The first processing apparatus 10 may include a first cabinet 110 defining an exterior. The first cabinet 110 may include a first front panel 112 arranged on a front side. The first front panel 112 may include a laundry opening in communication with the inside of the first drum 12. The clothing opening may be opened and closed by a first cabinet door 17. Through the clothing opening, clothing or the like required to be processed may be introduced into the first cabinet 110 and accommodated in the first drum 12. The first processing apparatus 10 may process the accommodated clothing. The first processing apparatus 10 may perform processing on the accommodated clothing, such as washing, drying, or the like.

The first processing apparatus 10 may be provided with a first side panel 115 arranged on each side facing in the side direction Y, a first rear panel (not shown) arranged on the rear side, a first top panel (not shown) arranged on the upper side, and a first bottom panel (not shown) arranged on the lower side.

The first front panel 112, the first side panel 115, the first rear panel (not shown), the first top panel 119, and the first bottom panel (not shown) may be combined with each other to form the first cabinet 110, and may be coupled to each other. The first cabinet 110 may define a space in which built-in components constituting the first processing apparatus 10, such as the first drum 12, are arranged. A detergent opening is formed in the first front panel 112, and the detergent storage part 30 is inserted into the detergent opening. In the laundry treating apparatus 1 according to one embodiment, the first processing apparatus 10 is arranged on the ground. The detergent storage part 30 may be positioned above the clothing opening of the first processing apparatus 10, such that insertion and withdrawal of the detergent storage part 30 may be facilitated. The detergent storage part 30 may be positioned between the clothing opening of the first processing apparatus 10 and the control panel 2000. The detergent storage part 30 may be positioned above the clothing opening of the first processing apparatus 10 and below the control panel 2000. The detergent storage part 30 may be inserted into or drawn out of the first cabinet 110 by a user. For example, the user may separate the detergent storage part 30 from the first cabinet 110, store detergent in the detergent storage part 30, and then insert the detergent storage part 30 back into the first cabinet 110.

In one embodiment, a filter opening is formed in the first front panel 112. A filter part 40 is inserted into the filter opening. The filter part 40 is configured to capture foreign matter from the wash water. Through the filter opening, the filter part 40 may be introduced into the first cabinet 110. The filter part 40 may be arranged on one side of a lower portion of the first front panel 112. The filter part 40 may be connected to the flow path for which wash water discharged from the tub 14. The filter part 40 may filter out foreign matter from the wash water discharged from the tub 14 after the washing process is performed. The function of the filter part 40 is not necessarily limited thereto, and may be arranged to filter out foreign matter from various objects. For example, the filter part 40 may be arranged to filter out foreign matter from wash water for the wash cycle prior to the wash cycle.

A user may insert or withdraw the filter part 40 into or out of the first cabinet 110 through the filter opening. Once withdrawn, the filter part 40 may be cleaned and reused or may be replaced. The filter part 40 may have a longer cycle of insertion and withdrawal than the detergent storage part 16. Accordingly, in one embodiment of the present disclosure, the detergent opening through which the detergent storage part 30 having a relatively short insertion and withdrawal cycle is inserted may be disposed on the upper side of the first front panel 112. Also, the filter opening through which the filter part 40 having a relatively long insertion and withdrawal cycle is inserted may be disposed on the lower side of the first front panel 112 to realize the structure of the first front panel 112 that provides excellent space utilization while improving user convenience.

Further, the wash water discharge flow path connected to the tub 14 inside the first cabinet 110 may be positioned on a lower side within the first cabinet 110 to facilitate the discharge of wash water. In one embodiment of the present disclosure, the filter part 40 may be arranged on the lower side of the first cabinet 110 to efficiently connect with the wash water discharge path.

The first processing apparatus 10 may be provided with a first apparatus controller 19. The first apparatus controller 19 is configured to control various apparatuses including the first processing apparatus 10. The first apparatus controller 19 is disposed inside the first cabinet 110. The first apparatus controller 19 may include a circuit board and electronic components mounted on the circuit board. In an embodiment, the first apparatus controller 19 may check information corresponding to an operation signal received through the control panel 2000 in a memory and perform apparatus control corresponding to the operation signal based on the information. The first apparatus controller 19 may transmit the status of the first processing apparatus 10 to the control panel 2000.

In an embodiment, the second processing apparatus 20 is positioned on the upper side of the first processing apparatus 10. The first processing apparatus 10 supports the second processing apparatus 20. The second processing apparatus 20 may correspond to a dryer for drying clothing. The second processing apparatus 20 may include a second drum 22. The second drum 22 may accommodate the clothing therein. In an embodiment, the second drum 22 has a rotation shaft arranged in the front-to-back direction (+X, −X).

The second processing apparatus 20 may include a second cabinet 120 defining an exterior. The second cabinet 120 may include a second front panel 122 arranged on a front side. The second front panel 122 may include a clothing opening communicating with the second drum 22. The clothing opening may be opened and closed by a second cabinet door 27.

The second processing apparatus 20 may be provided with a second side panel 125 on each side facing in the side direction (+Y, −Y). Further, the second processing apparatus 20 may have a second rear panel (not shown) arranged on the rear side, a second top panel (not shown) arranged on the upper side, and a second bottom panel (not shown) arranged on the lower side.

In an embodiment, the second front panel 122, the second side panel 125, the second rear panel (not shown), the second top panel 127, and the second bottom panel (not shown) may be combined with each other to form the second cabinet 120, and may be coupled to each other. The second cabinet 120 may define a space in which built-in components constituting the second processing apparatus 20, such as the second drum 22, are arranged.

Clothing or the like required to be processed may be accommodated in the second drum 22 through the clothing opening in the second processing apparatus 20. The second processing apparatus 20 may process the accommodated clothing, and the clothing accommodated in the second drum 22 may be subjected to processing such as washing, drying, and the like by the second processing apparatus 20.

The second processing apparatus 20 is disposed on top of the first processing apparatus 10. In one embodiment, the upper portion of the first processing apparatus 10 may be coupled to the lower portion of the second processing apparatus 20. A structure that supports the second processing apparatus 20 may be provided on the top side of the first processing apparatus 10. For example, the first top panel (not shown) of the first processing apparatus 10 may have a structure that directly or indirectly supports the second bottom panel (not shown) of the second processing apparatus 20.

The second processing apparatus 20 may be provided with a second apparatus controller 29. The second apparatus controller 29 is configured to control various devices constituting the second processing apparatus 20. The second apparatus controller 29 is disposed inside the second cabinet 120. The second apparatus controller 29 may include a circuit board and electronic components mounted on the circuit board. In an embodiment, the second apparatus controller 29 may check information corresponding to an operation signal received through the control panel 2000 in a memory and perform apparatus control corresponding to the operation signal. The second apparatus controller 29 may transmit the status of the second processing apparatus 20 to the control panel 2000.

The control panel 2000 is disposed between the first front panel 112 and the second front panel 122. The control panel 2000 may be positioned at a height approximately corresponding to the waist of the user. When the control panel 2000 is positioned at a height approximately corresponding to the user's waist, operational convenience may be enhanced for the user. In an embodiment, the control panel 2000 is positioned above the first front panel 112 and below the second front panel 122, and the height of the first front panel 112 and the height of the second front panel 122 may be set appropriately. In some embodiments, at least a portion of the first front panel 112 may face the side panel 125 of the second processing apparatus 20.

The control panel 2000 may be connected to at least one of the first processing apparatus 10 and the second processing apparatus 20 to transmit and receive signals. In an embodiment, the control panel 2000 is connected to transmit and receive signals to and from the first processing apparatus 10 and the second processing apparatus 20. In an embodiment, the control panel 2000 is connected to transmit and receive signals to and from the first apparatus controller 19 and/or the second processing apparatus 20. The connections described above may include wired or wireless connections.

A front portion 2110 of the control panel 2000 is provided with a user interface (UI) part 200 on which a UI is displayed.

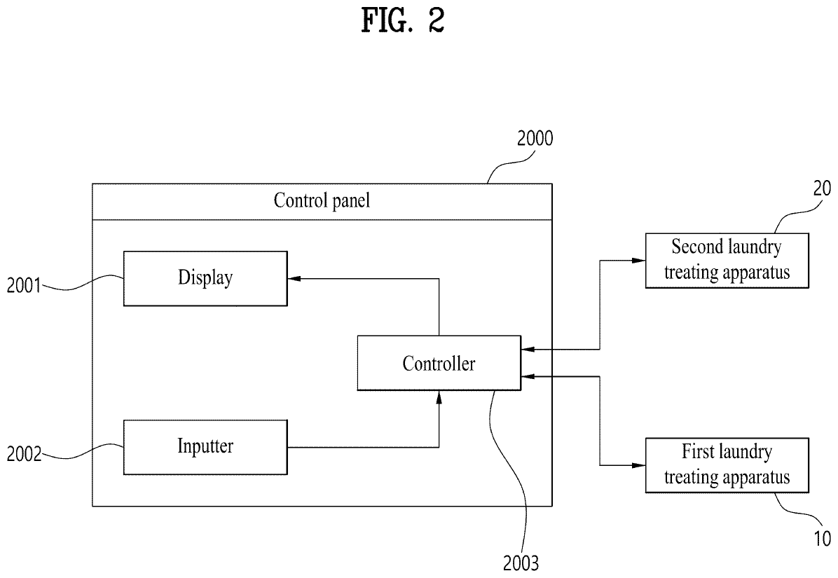

FIG. 2 is a schematic diagram illustrating the interrelationship between a control panel 2000, the first processing apparatus 10, and the second processing apparatus 20 according to one embodiment of the present disclosure.

According to one embodiment of the present disclosure, the control panel 2000 may include a display part 2001, an input part 2002, and a controller 2003. The UI part 200 may include the display part 2001 and the input part 2002.

The display part 2001 is an element to display one or more pieces of information for interaction with a user. The display part 2001 may indicate the status of the first processing apparatus 10 and/or the second processing apparatus 20. The display part 2001 may display the status of the first processing apparatus 10 and/or the second processing apparatus 20. The display part 2001 is provided in the UI part 200. The display part 2001 displays information about at least one of the first processing apparatus 10 and the second processing apparatus 20. In an embodiment, the information includes information about courses that may be executed on the first processing apparatus 10 and/or the second processing apparatus 20, information (related to, for example, a course name and time remaining until the course is completed) about processing that is operating on the first processing apparatus 10 and/or the second processing apparatus 20, information about an ongoing cycle (e.g., the name of the cycle), information about a set processing option, information about a communication connection status, information about a remote control setting, information about a door lock status, information about a drying preparation setting, information about a turbo shot setting, information about a steam setting, information about an ironing alarm setting, information about a wrinkle prevention setting, and information about a reservation setting.

The input part 2002 is configured to receive input from a user for operational instructions for control of the first processing apparatus 10 and/or the second processing apparatus 20. The input part 2002 may be provided on the control panel 2000. The input part 2002 may be provided as a touch screen. The input part 2002 may be provided as a touch sensor. The input part 2002 may be provided as a physical button.

The controller 2003 may include a microprocessor configured to execute control of the first processing apparatus 10 and/or the second processing apparatus 20, and a memory storing a control program for executing control of the first processing apparatus 10 and/or the second processing apparatus 20. The control program may be stored on a memory medium in the memory, wherein the memory medium may be a hard disk, a disc such as a CD-ROM or DVD, or a semiconductor memory such as flash memory. The controller 2003 may be arranged inside the control panel 2000, i.e., on the rear side of the front portion 2110. The controller 2003 may include one or more controllers. The controller 2003 may be connected to the first processing apparatus 10 and/or the second processing apparatus 20 to transmit and receive signals. The connection may include a wired connection or a wireless connection.

The controller 2003 may be connected to the display part 2001 and/or the input part 2002 to transmit and receive signals. The signals may include a control command, user input, and apparatus status information. The controller 2003 may detect operation signals from the input part 2002. The controller 2003 may check information corresponding to the input operation signal in the memory. The controller 2003 may transmit display data to the display part 2001. The display part 2001 may display the status of the first processing apparatus 10, the status of the second processing apparatus 20, and/or the content of the command input from the user in response to the display data received from the controller 2003. The controller 2003 may switch the components constituting the input part 2002 to an enabled or disabled state. The controller 2003 may switch the components constituting the display part 2001 to an enabled or disabled state. The controller 2003 may include a circuit board, and electronics mounted on the circuit board.

Although the controller 2003 is described as being included in the control panel 2000 in the embodiment, the controller 2003 may not be categorized as part of the control panel 2000. The controller 2003 may be arranged at a location other than the control panel 2000. The controller 2003 may be provided on the first processing apparatus 10 and/or the second processing apparatus 20. The controller 2003 may be provided on each of the control panel 2000, the first processing apparatus 10, and the second processing apparatus 20. The controller 2003 may be integrated with the first apparatus controller 19 and/or the second apparatus controller 29. Alternatively, the controller 2003 may be understood as integrated with the first apparatus controller 19 and/or the second device controller 29.

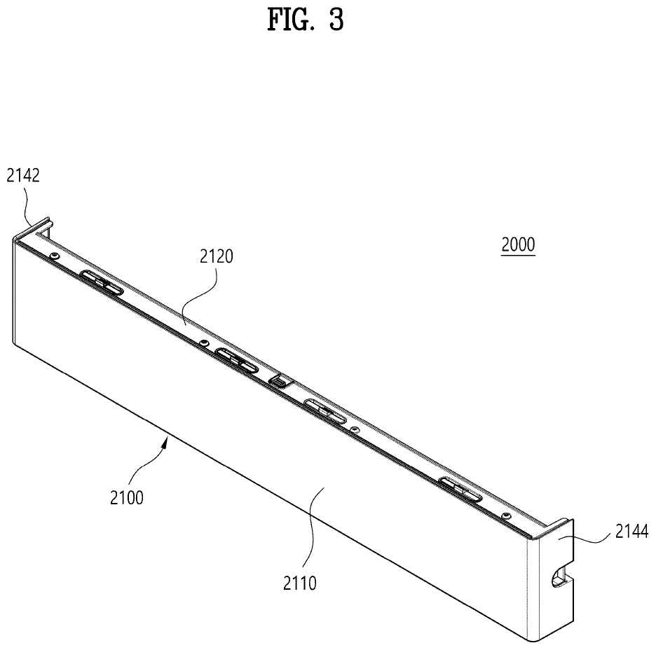

FIG. 3 is a front perspective view of a control panel according to one embodiment of the present disclosure. Hereinafter, a description will be given with reference to FIG. 3.

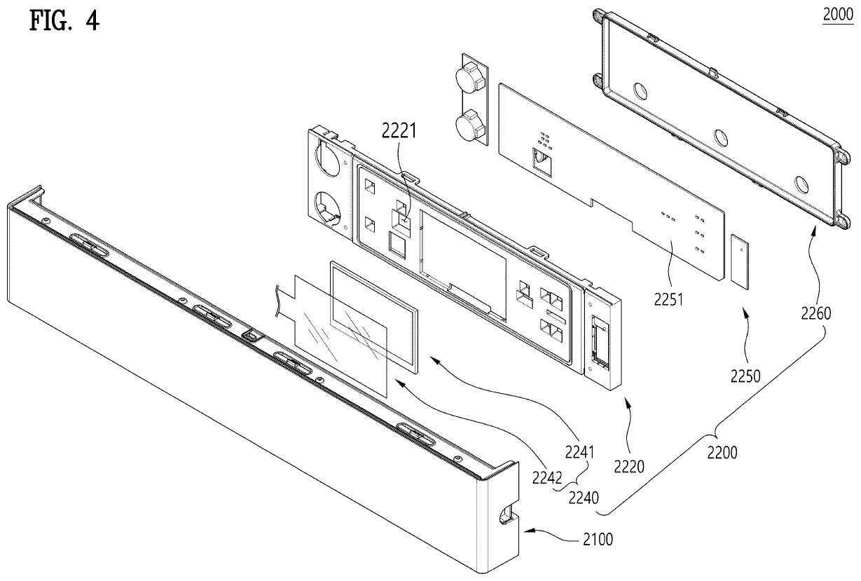

The control panel 2000 includes a cover panel 2100. An electronics module 2200 (see FIG. 4) is positioned at the rear of the cover panel 2100. The cover panel 2100 includes a front portion 2110, a top portion 2120, a bottom portion (not shown), a first side portion 2142, and a second side portion 2144. The front portion 2110 defines the exterior of the cover panel 2100. The top portion 2120 extends rearward from the top surface of the front portion 2110. The bottom portion 2130 extends rearward from the bottom surface of the front portion 2110. The first side portion 2142 extends rearward from a first side surface (e.g., the left side surface when viewed from the front) of the front portion 2110. The second side portion 2144 extends rearward from a second side surface (e.g., the right side surface when viewed from the front) of the front portion 2110.

FIG. 4 is an exploded perspective view of a control panel according to one embodiment of the present disclosure.

The control panel 2000 includes a cover panel 2100 and an electronics module 2200. The electronics module 2200 is coupled to the cover panel 2100 at the rear of the cover panel 2100. The electronics module 2200 includes a supporter 2220, a sealing cover 2230, a touch screen device 2240, and a circuit board 2250.

The touch screen device 2240 may include a combination of a flat panel display 2241 and a touch layer 2242. The flat panel display 2241 provides a screen that outputs images. The flat panel display 2241 functions as a display part for displaying various kinds of information. In the description of the present disclosure, the flat panel display 2241 refers to a thin display, which may be provided in various forms, such as LCD, PDP, AMLCD, PMLCD, OLED, and LED. In one embodiment, the touch layer 2242 may be provided as a touch film, a coating film, or the like. In the embodiment, the touch layer 2242 may include two ITO layers forming the X and Y axes. The touch layer 2242 functions as an input part through which touch input is received from a user. In an embodiment, the touch screen device 2240 may also be implemented by methods not illustrated in the figure. For example, the touch screen device 2240 may be implemented by a resistive method, a capacitive method, an infrared method, an ultrasonic method, or the like.

The supporter 2220 is configured to support the flat panel display 2241. The supporter 2220 has a panel-shaped front surface. The supporter 2220 is coupled to the top portion 2120 and the bottom portion (not shown) of the cover panel 2100. The flat panel display 2241 is positioned on the front surface of the supporter 2220. The flat panel display 2241 is supported by the supporter 2220. The flat panel display 2241 is positioned between the cover panel 2100 and the supporter 2220.

The sealing cover 2230 is positioned at the rear of the supporter 2220 and is coupled to the supporter 2220. The sealing cover 2230 covers the circuit board 2250. The sealing cover 2230 is positioned at the rear of the circuit board 2250. The circuit board 2250 is positioned in the space defined between the sealing cover 2230 and the supporter 2220.

The circuit board 2250 may include multiple circuit boards. Some circuit boards of the circuit board 2250 may be covered by the cover panel 2100 to prevent contact with external air. The circuit board 2250 may include a circuit board for a speaker, which will be described later, a circuit board for the flat panel display 2241 and touch buttons provided as input buttons, and a circuit board for the communication module. The circuit board for the flat panel display 2241 is electrically connected to the flat panel display 2241 to provide signals to the flat panel display 2241, and may also receive input signals from the user via the UI. In an embodiment, the circuit board for the flat panel display 2241 may be covered by the sealing cover 2230 to prevent contact with external air.

In the circuit board 2250, the circuit board 2251 for the flat panel display 2241 is provided with a touch button. The touch button is provided with a light emitting member and a touch sensor as a pair. The touch button may be provided as any known component capable of receiving touch input. The light emitting member indicates whether the corresponding touch sensor is enabled. For example, when the touch sensor is enabled, the light emitting member is caused to emit light. The light emitting member may be an LED element. The supporter 2220 may focus light diffused from the light emitting element to a specific location. In an embodiment, the supporter 2220 has one or more sensor holes 2221 formed therein. The sensor holes 2221 are formed at locations corresponding to the locations where touch buttons are arranged. The sensor holes 2221 define a barrier extending forward or rearward from a perimeter of the holes. The barrier prevents light emitted from the light emitting element from spreading to the surrounding area of the touch button. By disposing the circuit board 2510 behind the supporter 2220, the light from the touch button may be prevented from spreading.

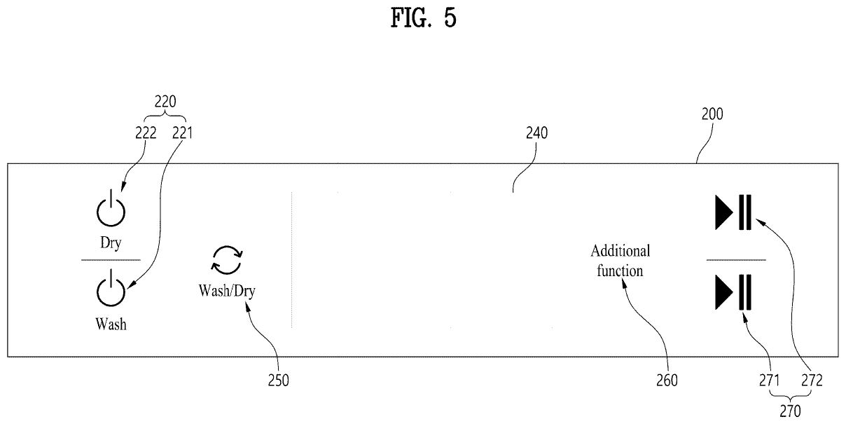

FIG. 5 illustrates a UI part 200 according to one embodiment of the present disclosure. The UI part 200 is provided with a user interface (UI). The UI included in the UI part 200 may include a power button 220, a switching button 250, a touch screen 240, an additional function button 260, and a start/pause button 270. The power button 220 may include a first power button 221 and a second power button 222. The start/pause button 270 may include a first start/pause button 271 and a second start/pause button 272.

The first power button 221, the second power button 222, the switching button 250, the additional function button 260, the first start/pause button 271, and the second start/pause button 272 may be provided as touch sensors or physical buttons. The touch screen 240 may be provided by the touch screen device 2240.

The first power button 221 may be represented by an icon in the form of a power symbol. The first power button 221 is configured to receive a user command to power the first processing apparatus 10 on and off. In an embodiment, the first power button 221 is provided as a touch sensor. In an embodiment, when the user touches the first power button 221, the controller 2003 may receive a turn-on or turn-off command for the first processing apparatus 10.

The second power button 222 may be represented by an icon in the form of a power symbol. The second power button 222 is disposed to occupy a different area than the first power button 221. In an embodiment, the first power button 221 and the second power button 222 may be disposed up and down. In an embodiment, the second power button 222 is disposed above the first power button 221. The second power button 222 is configured to receive a user command to power the second processing apparatus 20 on and off. In an embodiment, the second power button 222 is provided as a touch sensor. In an embodiment, when the user touches the second power button 222, the controller 2003 may receive a turn-on or turn-off command for the second processing apparatus 20.

The first power button 221 and the second power button 222 may be provided as separate touch sensors that are separate from the touch input element (e.g., touch layer) for the touch screen 240. By providing the first power button 221 and the second power button 222 in an area separate from the touch screen 240, the chances of malfunction of the apparatus may be reduced. The laundry treating apparatus 1 is placed in a moist environment. By separating the area of the touch input element (e.g., touch layer) for the touch screen 240 from the area of the first power button 221 and the second power button 222, touch malfunctions due to moisture may be minimized. For example, the second processing apparatus 20 is turned on and access to the second apparatus operation UI is attempted while the first processing apparatus 10 is operating, touch malfunction due to moisture may be avoided, such as unintentionally changing options on the first processing apparatus 10.

The touch screen 240 may be disposed to occupy a different area than the first power button 221 and the second power button 222. The touch screen 240 may be implemented by the touch layer 2242, which is included in the input part 2002, and a flat panel display 2241, which is included in the display part 2001. The touch screen 240 may output one of a first apparatus operation UI for controlling the first processing apparatus 10, a second apparatus operation UI for controlling the second processing apparatus 20, and a composite UI for displaying operation information about the first processing apparatus 10 and the second processing apparatus 20 on a single screen. The first apparatus operation UI, the second apparatus operation UI, and the composite UI will be described in more detail below.

The switching button 250 is disposed to occupy a different area than the first power button 221, the second power button 222, and the touch screen 240. The switching button 250 may be provided as a separate touch sensor that is separate from the touch layer 2242 included in the touch screen 240. By providing the switching button 250 in an area separate from the touch screen 240, the chances of malfunction of the apparatus may be reduced. The laundry treating apparatus 1 is placed in a moist environment. By separating the area of the touch layer 2242 included in the touch screen 240 from the area of the switching button 250, touch malfunctions due to moisture may be minimized. For example, the second processing apparatus 20 is turned on and access to the second apparatus operation UI is attempted while the first processing apparatus 10 is operating, touch malfunction due to moisture may be avoided, such as unintentionally changing options on the first processing apparatus 10.

The switching button 250 may be represented by an icon in the form of a symbolizing switching. The switching button 250 receives user input to switch between control targets. It is enabled when both the first processing apparatus 10 and the second processing apparatus 20 are in the On state. When a user command is input through the switching button 250 while the first apparatus operation UI is displayed on the touch screen 240, the control target is switched to the second processing apparatus 20, and the second apparatus operation UI is displayed on the touch screen 240. When a user input is received through the switching button 250 while the second apparatus operation UI is displayed on the touch screen 240, the control target is switched to the first processing apparatus 10 and the first apparatus operation UI is displayed on the touch screen 240. The switching button 250 is disabled when at least one of the first processing apparatus 10 and the second processing apparatus 20 is powered off.

The additional function button 260 may be displayed in the form of text that reads “Additional Function.” The additional function button 260 is disposed to occupy a different area than the first power button 221, the second power button 222, the touch screen 240, and the switching button 250. The additional function button 260 receives user input for setting additional functions of the first processing apparatus 10 and/or the second processing apparatus 20. In an embodiment, when the user touches the additional function button 260, the touch screen 240 may display items for establishing additional settings (e.g., scheduling, alarm tone volume, etc.) for the first processing apparatus 10 and/or the second processing apparatus 20.

The first start/pause button 271 may be represented by an icon in the form of a play symbol and a pause symbol. The first start/pause button 271 is disposed to occupy a different area than the first power button 221, the second power button 222, the touch screen 240, the switching button 250, and the additional function button 260. The first power button 221 receives a user input for starting or pausing the operation of the washing machine 10.

The second start/pause button 272 may be represented by an icon in the form of a play symbol and a pause symbol. The second start/pause button 272 is disposed to occupy a different area than the first power button 221, the second power button 222, the touch screen 240, the switching button 250, the additional function button 260, and the first start/pause button 271. The first start/pause button 271 and the second start/pause button 272 may be disposed up or down. In an embodiment, the second start/pause button 272 may be disposed above the first start/pause button 271. The second power button 222 receives a user command to start or pause the operation of the second processing apparatus 20.

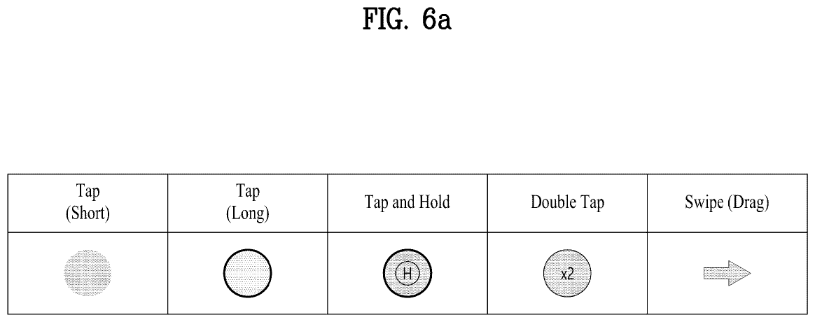

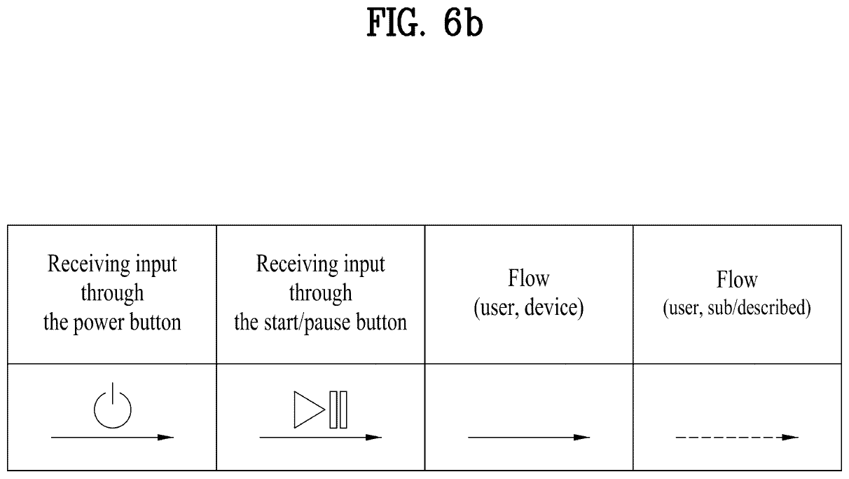

FIG. 6A shows a table listing features representing various touch gestures on a touch input part (including, for example, various buttons and a touch screen) distinguished from each other according to one embodiment of the present disclosure. In the present disclosure, multiple touch methods are applied. The multiple touch input methods may be implemented by various touch gestures. In the drawings described hereinafter, the features shown in FIG. 6A are used to represent the behavior of a user providing a touch command.

A Tap (Short) gesture is a method of inputting a command with a short tap on the touch screen 240 by a user. The Tap (Short) gesture may be described as a short, light tap of the user's finger on the touch screen 240. The input command may cause a set function to be executed. In the present disclosure, the feature representing the Tap (Short) gesture is a solid circle with no border.

A Tap (Long) gesture is a method of inputting, by a user, a command by touching the touch screen 240 for a set time or longer. The input command may cause a set function to be executed. Generally, “touching for a set time or longer” is expressed as “touching for a long time.” “Touching for a set time or longer” may mean “touching a specific part of the touch screen 240 and not releasing the finger until a set response.” The time during which the touch is maintained, i.e., the time during which the finger remains in contact, may depend on the setting. However, it may be set to approximately 1 second or longer, as it corresponds to the time making a user to perceive not just a simple tap but a sustained touch. In the present disclosure, the feature representing the Tap (Long) gesture is a solid circle with a border.

A Tap and Hold gesture is a method of inputting a command by a user by continuously holding a touch on the touch screen 240. For example, different commands may be input depending on the duration for which the user's touch is held for the Tap and Hold gesture. The input command may cause a set function to be executed. When the Tap and Hold gesture is detected, different outputs are generated depending on the duration of the touch. For example, pressing the scroll arrow continuously to move a list corresponds to the Tap and Hold gesture. In the present disclosure, the feature representing the Tap and Hold gesture is a solid circle with a border and ‘\textcircled{H}’ written inside.

The Double Tap gesture is a method of inputting a command by a user by making two short consecutive taps on the touch screen 240. The feature representing the Double Tap gesture is a solid circle with a border and ‘x2’ written inside.

A Swipe gesture is a method of inputting a command by a user by touching a location on the touch screen 240 and moving the finger to another location without lifting the finger. By general definition, the Swipe gesture is a motion of sliding a finger kept in contact with the touch screen 240. The feature representing the Swipe gesture is a solid arrow with no border. The direction of the arrow may be defined by the direction of movement of the finger.

FIG. 6B illustrates the flow of image transitions on the screen and shows a table listing features that distinguish the transitions based on their causes. In the drawings described below, the features shown in FIG. 6B are used to simplify the representation of the image transition flow.

The flow of a change resulting from receiving input through the power button is represented by a combination of a solid arrow and an icon representing power that is placed adjacent to the solid arrow.

The flow of a change resulting from receiving input through the Start/Pause button is represented by a combination of a solid arrow and an icon representing Start/Pause that is placed adjacent to the solid arrow.

The flow of a change resulting from a user command input through the UI part 200 is represented by a solid arrow. The flow of a change resulting from a non-typical situation (e.g., the occurrence of an error, a warning, a user notification, etc.) in the laundry treating apparatus 1 is also represented by a solid arrow.

The flow of a change resulting from a preset programming or the like, even though no user command is received, is represented by a dotted arrow. For example, this flow may occur when the preset conditions are satisfied by the preset programming or the like.

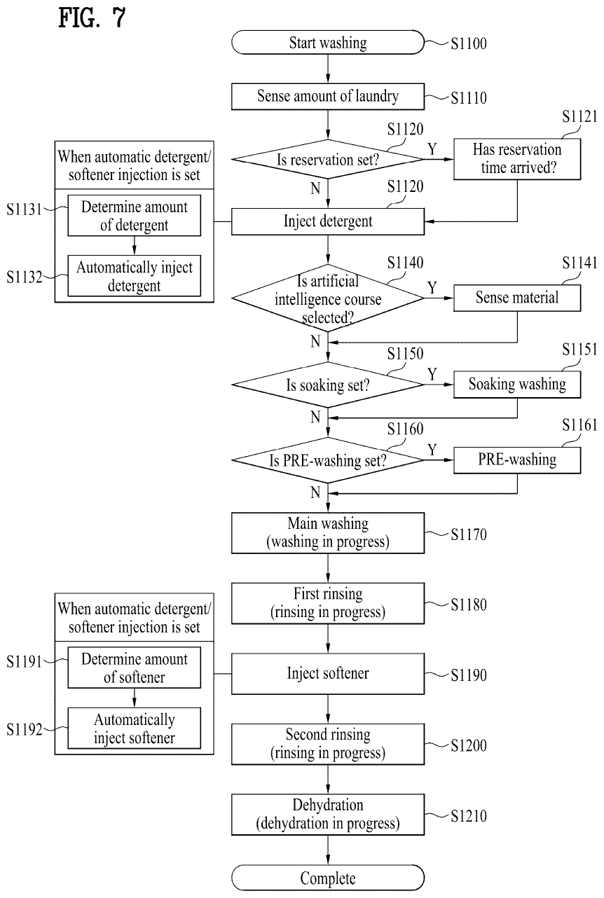

FIG. 7 illustrates a cycle flow according to one embodiment when a washing machine is provided as a first processing apparatus or a second processing apparatus. Hereinafter, a cycle flow according to one embodiment will be described with reference to FIG. 7. In the description of the present disclosure, a washing machine is provided as an embodiment of the first processing apparatus 10.

A user loads a laundry item to be processed into the first drum 12. The user may close the first cabinet door 17 of the first processing apparatus 10 and input an execution command to start washing. Laundry processing may be started by the user's command (S1100). The laundry processing may be performed based on a wash course selected by the user. In the present disclosure, the wash courses is defined as a set of control methods for processing a laundry item by controlling the components of the first processing apparatus 10 to perform operations including rotating the first drum 12, supplying water, detergent and/or softener into the first drum 12, and draining the wash water filled in the first drum 12.

Prior to the various substantive cycles related to the laundry processing, the amount of fabrics of the laundry item is sensed (S1110). For cycles processed thereafter, the amount of the detergent, the amount of the softener, the amount of wash water for washing, the amount of rinse water for rinsing, a wash time, a rinse time, a dehydration time, and the like may be set based on the sensed amount of fabrics.

It is determined whether a reservation is set (S1120). The reservation may be set through a reservation option. The reservation option may refer to an option to delay the end of a course. The reservation option may be very useful when the user is going out for a long period of time. In other words, it allows the user to set the washing to finish in time for their return home. Accordingly, it may eliminate the need to wait for the washing to finish or prevent the washed laundry from being left in the washing machine for a long period of time. If the reservation is set (Y), the process proceeds to the next step when the reserved time arrives (S1121). If no reservation is set (N), the process proceeds to the next step immediately.

The detergent required for washing is introduced into the first drum 12 (S1130). In an embodiment, the detergent may be supplied together with wash water. In the case where the ‘Automatic detergent/softener introduction’ function is set as an additional function of the first processing apparatus 10, the amount of detergent to be introduced is determined based on the sensed amount of fabrics (S1131), and the detergent is introduced automatically (S1132).

In an embodiment, the first processing apparatus 10 may provide an artificial intelligence (AI) course as an example of wash courses. The AI course is a course in which the characteristics and contamination of the laundry are sensed and a series of wash cycles are performed with an option selected as optimal. It is checked whether the selected course is an AI course (S1140). If the AI course is selected (Y), the next step is to sense the material of the laundry item (S1141). The step of sensing the material of the laundry item may be implemented by various methods. The details of the material sensing will not be described herein.

In an embodiment, the first processing apparatus 10 may provide a soaking option as one of the wash options. The soaking option allows the laundry items to be immersed in the wash water for a set period of time during the wash cycle, helping to loosen contaminants. It is checked whether the soaking option is set as a wash option (S1150). If the soaking option is selected (Y), a soaking wash step may be performed (S1141). The soaking wash may be applied in the main wash cycle (S1170), which will be described later.

In an embodiment, the first processing apparatus 10 may provide a pre-wash option as one of the wash options. The pre-wash option adds a pre-wash cycle. The pre-wash cycle, which is pre-processing the laundry prior to the main wash cycle (S1170), is a simpler cycle to wash the laundry than the main wash cycle. It is checked whether the pre-wash option is set as a wash option (S1160). If the pre-wash option is selected (Y), a pre-wash step is performed (S1161).

The main wash cycle is performed (S1170). While the wash cycle is in progress, the first apparatus operation UI 300 may indicate “Washing.” The main wash cycle is a process of separating contaminants from the laundry items using wash water containing detergent. In the main wash cycle, the first drum 12 alternates between clockwise and counterclockwise rotations, causing friction and tumbling of the laundry items. The laundry item and contaminants may be separated through friction, tumbling, and the surfactant action of the detergent.

A first rinse cycle is performed (S1180). During the first rinse cycle, the first apparatus operation UI 300 may indicate “Rinsing.” The first rinse cycle uses water to separate contaminants from the laundry item. In an embodiment, the contaminants separated in the main wash cycle may be removed in the first rinse cycle. In an embodiment, in the first rinse cycle, the wash water used in the main wash cycle may be drained. Fresh water is supplied to the first drum 12 from which the wash water has been drained, and the first drum 12 is rotated to separate contaminants from the laundry item. In the first rinse cycle, the draining step of discharging the water from the first drum 12 and the water supply step of supplying fresh water to the first drum 12 may be performed once or more. In an embodiment, the number of times draining and water supply are performed in the first rinse cycle may be set by the user.

When set, a softener is introduced into the first drum 12 (S1190). In an embodiment, the softener may be supplied together with water. In the case where the ‘Automatic detergent/softener introduction’ function is set as an additional function of the first processing apparatus 10, the amount of softener to be introduced is determined based on the sensed amount of fabrics (S1191) and the softener is automatically introduced (S1192). The softener softens the laundry item.

A second rinse cycle is performed (S1200). During the second rinse cycle, the first apparatus operation UI 300 may indicate “Rinsing.” The second rinse cycle is a process of rinsing the laundry item using water. In an embodiment, in the second rinse cycle, the softener-added water filled in the first drum 12 is drained, fresh water is supplied into the first drum 12, and the first drum 12 is rotated.

The dehydration cycle is performed (S1210). The dehydration cycle is a process of removing water from the laundry item. In the dehydration step, the water contained in the first drum 12 is drained. After the water is drained from the first drum 12, the first drum 12 is rotated. The centrifugal force of the rotation acts on the water absorbed by the laundry item, and water is removed from the laundry item. In an embodiment, the first drum 12 may alternate between clockwise and counterclockwise rotations. By alternating the direction of rotation, the laundry items may be prevented from being entangled with each other.

Through the above-described series of processes, the laundry items may be washed. The series of processes in which the laundry items are washed may be referred to as a wash course. The wash course is a type of processing courses for processing clothing. In an embodiment, the processing of the clothing is washing the clothing. A series of processes in which clothing is processed using a combination of elements (e.g., various cycles, water temperature, amount of water, etc.) may be defined as a wash cycle.

Wash courses may be provided in various ways. In an embodiment, multiple wash courses may be defined. The multiple defined wash courses may be provided to be selected by a user through the UI part 200. The user may select one of the multiple set wash courses to proceed with a series of processes using the first processing apparatus 10.

The wash courses may be provided in various ways according to the cycle in each step. One or more wash courses may be defined as different wash courses depending on the presence or absence of each cycle. The one or more wash courses may be defined as different wash courses depending on whether additional functions are set. The one or more wash courses may be defined as different wash courses according to various parameters defined and set for washing. The various defined and set parameters may be provided as optimized values for washing laundry items.

In an embodiment, depending on each wash course, the cycles, additional functions and/or parameters (water temperature, number of rinses, drum rotation RPM, washing time, dehydration time, etc.) may vary. To distinguish between the various wash courses, each wash course may have a unique name (wash course name). For example, the wash courses may be named to reflect their characteristics, such as “Standard Washing,” “Small Load Quick Washing,” “Delicate/Wool,” or “AI Washing.”

The user may select one of the multiple set wash courses. In an embodiment, at least one of the multiple wash courses is provided with one or more options. In an embodiment, multiple options may be provided for at least one of the multiple wash courses. In a wash course in which preset elements are provided as default elements, any element of the preset elements that is provided to be changed by the user may be defined as an option. An option may be defined as one or more elements, and/or a combination thereof, that may be changed or selected by the user among the elements constituting the wash course.

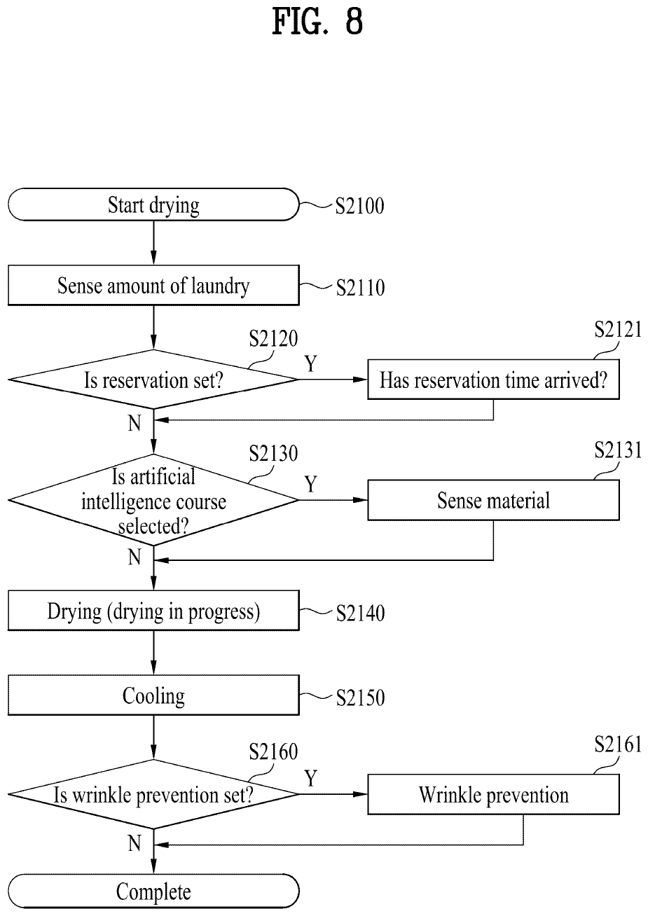

FIG. 8 illustrates a cycle flow according to one embodiment when a dryer is provided as the first processing apparatus or the second processing apparatus according to one embodiment of the present disclosure. Hereinafter, a cycle flow according to one embodiment will be described with reference to FIG. 8. In the description of the present disclosure, a dryer is provided as an embodiment of the second processing apparatus 20.

A user introduces a laundry item that needs to be processed into the second drum 22. The user may input an execution command to close the second cabinet door 27 of the second processing apparatus 20 and start drying. Based on the command from the user, the drying process may start (S2100). The drying process may be performed based on a drying course selected by the user. In the present disclosure, the drying course is defined as a set of control methods for processing an object to be dried by controlling the components of the second processing apparatus 20, including rotating the second drum 22, and replacing the air inside the second drum 22 using a heat exchanger (not shown) such as a heat pump to discharge moisture.

Prior to the various substantive cycles related to the drying process, the amount of fabrics of the object to be dried is sensed (S2110). Based on the sensed amount of fabrics, the drying time, cooling time, whether to supply steam, etc. may be set for subsequent cycles.

It is determined whether a reservation is set (S2120). If a reservation is set (Y), proceed to the next step when the reservation time arrives (S2121). If no appointment is set (N), proceed to the next step immediately.

In an embodiment, the second processing apparatus 20 may provide an AI course as an example of the drying course. The AI course is a course in which the characteristics and weight of the object to be dried are sensed and a series of drying cycles are performed with an option selected as optimal. It is checked whether the selected course is an AI course (S2130). If the AI course is selected (Y), the next step is to sense the material of fabrics of the object to be dried (S2131). The step of sensing the material of the material of fabrics of the object to be dried may be implemented by various methods. The details of the sensing of the material of the fabrics will not be described herein.

The drying cycle is performed (S2140). During the drying cycle, the second apparatus operation UI may indicate “Drying.” The drying cycle is a process of separating moisture contained in the object to be dried from the object. In the drying cycle, the air inside the second drum 22 is circulated. While the air is circulated, moisture is removed. Moisture may be removed from the object to be dried by the moisture-removed air. In the drying cycle, the second drum 22 may rotate clockwise, may rotate counterclockwise, or may alternate between clockwise and counterclockwise rotations. The object to be dried may fall due to rotation of the second drum 22. While the object to be dried falls, the area in contact with the air may increase, thereby enhancing drying efficiency.

The cooling cycle is performed (S2150). The cooling cycle is performed after the drying cycle. The cooling cycle is a process of reducing the temperature inside the second drum 22 below a set temperature. Since the internal temperature of the second drum 22 may be high after the drying cycle, which may be dangerous, the cooling cycle is performed to reduce the internal temperature of the second drum 22.

In an embodiment, the second processing apparatus 20 may provide an anti-wrinkle option as one of the drying options. When the wrinkle prevention option is set, the option causes the second drum 22 to rotate periodically even after the drying course is completed to prevent the object to be dried from wrinkling after the drying cycle is completed. It is checked whether the wrinkle prevention option is set as a drying option (S2160). If the wrinkle prevention option is selected (Y), the wrinkle prevention operation may be performed for a set time (S2161). The set time may be set to a time for the user to open the second cabinet door 27 to withdraw the dried object from the second processing apparatus 20. The set time may be set to a time after a period of time that begins after the completion of the preceding cycle.

The object to be dried may be dried through the series of processes described above. The series of processes for drying the object to be dried may be referred to as a drying course. The drying course is a type of processing courses for processing clothing. In an embodiment, the processing of the clothing is drying the clothing. A series of processes for processing an object to be dried using a combination of elements (e.g., various cycles, air temperature, drying time, etc.) may be defined as a drying course.

The drying course may be provided in various ways. In an embodiment, multiple drying courses may be provided for definition. The multiple defined drying courses may be provided to be selected by a user through the UI part 200. The user may select one of the multiple defined drying courses to proceed with a series of processes using the second processing apparatus 20.

The drying courses may be provided in various ways according to the cycle in each step. One or more drying courses may be defined as different drying courses depending on the presence or absence of each cycle. The one or more drying courses may be defined as different drying courses depending on whether additional functions are set. The one or more drying courses may be defined as different drying courses according to various parameters defined and set for washing. The various defined and set parameters may be provided as optimized values for drying an object to be dried.

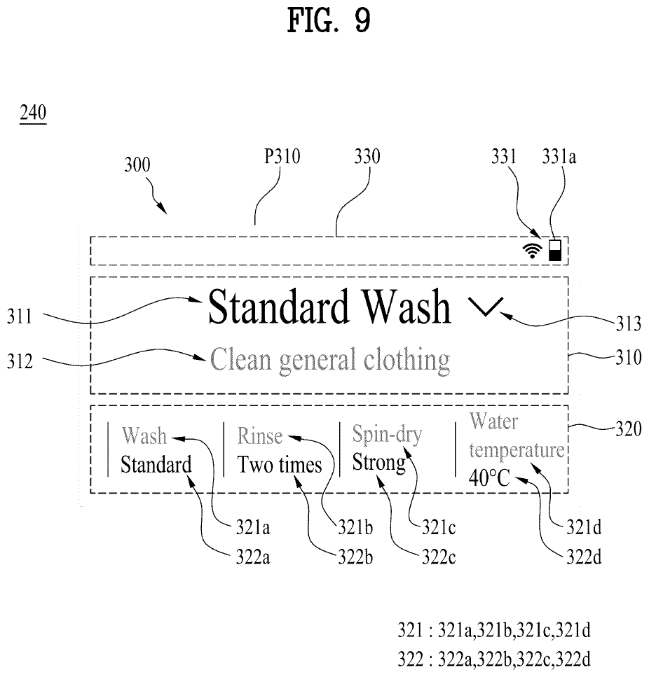

In an embodiment, depending on each drying course, the cycles, additional functions (steam supply option, wrinkle prevention option) and/or parameters (air temperature, drying time, drum rotation RPM, amount of steam) may vary. To distinguish between the various drying courses, each drying course may have a unique name (drying course name). For example, the drying courses may be named to reflect their characteristics, such as “Standard Drying,” “Small Load Quick Drying,” “Delicate/Wool,” or “Intensive Drying.” FIG. 9 illustrates the first apparatus operation UI 300 displayed on the touch screen 240 according to one embodiment of the present disclosure, wherein a course selection page P310 is output according to one embodiment. Hereinafter, a description will be given with reference to FIG. 9.

The course selection page P310 of the first apparatus operation UI 300 may be output on the touch screen 240. The course selection page P310 according to one embodiment includes a course display part 310, an option display part 320, and an indicator display part 330. In the course selection page P310, the course display part 310 may occupy a center area, the indicator display part 330 may occupy an upper area, and the option display part 320 may occupy a lower area. The indicator display part 330 may be disposed over the course display part 310, and the option display part 320 may be disposed under the course display part 310.

A course name 311, a course description 312, and a course browser 313 are displayed in the course display part 310.

The course name 311 is the name of a specific processing course that is currently in a specified state among multiple processing courses provided by the first processing apparatus 10. The course description 312 is a description of the specific processing course. The processing course and the course name 311 provided in the first apparatus operation UI 300 may correspond to the name of a wash course. The processing course and the course description 312 provided in the first apparatus operation UI 300 may correspond to a description of a wash course. In an embodiment, the course description of “Standard Washing” is “Making general clothing clean.” The course name 311 may be positioned above the course description 312. The font size for displaying the course name 311 may be larger than the font size for displaying the course description 312.

In an embodiment, the course browser 313 is positioned behind the course name 311. The course browse portion 313 may be positioned on a horizontal line that overlaps the course name 311. The position of the course browser 313 may vary depending on the length of the course name 311. The course browser 313 may be provided in the form of an icon. In the illustrated embodiment, the course browser 313 is represented in a ‘V’ shape. The course browser 313 functions as an input part. In the illustrated embodiment, when the course browser 313 is displayed, the touch screen 240 may output a course browse page (not shown) upon receiving a touch input to the setting area. The course browser page (not shown) is a page on which multiple course names corresponding to multiple processing courses are displayed as a list. In the course browser 313, the setting area that functions as an input part may be an area where the icon representing the course browser 313 and/or the course name 311 is displayed.

Option information is displayed in the option display part 320 displays. In an embodiment, an option name 321 and an option value 322 are displayed in the option display part 320. The option name 321 is the name of the option. The option value 322 is a value or condition of the option corresponding to the option name 321. The option name 321 may be positioned over the option value 322.

A processing course may provide various options. In an embodiment, various options may be selected to change preset values or conditions in a specific processing course. These options may be provided on the condition that the specific processing course is selected. The options may include changing the conditions for each of the cycles included in the processing course, enabling additional an additional cycle to be performed, and/or changing the time at which the course is to be completed (reservation setting).

In the illustrated embodiment, the processing course is the wash course. In the illustrated embodiment, the wash course may provide a wash option, the number of times of rinsing, dehydration intensity, and water temperature as options. The option name 321a for the wash option may be “Washing.” The option name 321b for the number of times of rinsing may be “Rinse”. The option name 321c for the dehydration intensity may be “Dehydration”. The option name 321d for the water temperature may be “Water temperature”.

In an embodiment, the option value 322 provided by each option of the wash course may provide multiple preset option values, any one of which is selectable. In an embodiment, the “Wash option” may provide choices such as “No,” “less often,” “Standard,” and “Strong,” as the option value 322.

In another embodiment not illustrated in the figure, the processing course is the drying course. In an embodiment, the drying course may provide an energy-saving mode, drying level, drying time, and wrinkle prevention as options. The option name for the energy-saving mode may be “Energy-saving mode.” The option name for the drying level may be “Drying level.” The option name for the drying time may be “Drying time.” The option name for the wrinkle prevention may be “Wrinkle prevention.”

In an embodiment, the option values provided by each option of the drying course may provide multiple preset option values, any one of which is selectable. In an embodiment, the option values for Wrinkle prevention” may include “On” and “Off,” which are selectable

The option value 322 outputs preset default values if not changed by the user. The default values may be preset values for the respective wash courses. When the option value 322 is changed from the default values, the default values may be stored and updated as values very frequently used based on the frequency of use of the changed option value 322.

In an embodiment, any of the multiple processing courses may provide one or more options among the multiple options that the first processing apparatus 10 may provide. The one or more options provided by a processing course are defined as options provided.

The option display part 320 may display an option set. The option set is a set including multiple preset options among the multiple options. In the illustrated embodiment, the option set may include “Washing,” “Rinse,” “Dehydration,” and “Water temperature.” The configuration of the options in the option set remains the same even when a specific course is changed. However, the default values in the option value may vary depending on the specific processing course. The specific course may not offer all the options in the option set. For options that are not provided by the specific processing course, the option value may be displayed as “-.”

Among the options provided by the option display part 320, the options for which the user can change the option value are represented by a first appearance, and the options for which the user cannot change the option value are represented by a second appearance. FIG. 9 shows a state in which the user can change the option value, as an example of the first appearance.

The indicator display part 330 may display one or more indicators 331. The indicators 331 are elements that indicate status information and configuration information about the apparatus. The indicators 331 may be represented as icons. The indicators 331 may be represented by respective icons for corresponding information. As the number of indicators 331 displayed increases, they may be accumulated from a first side to a second side and may be displayed so as not to overlap each other. In an embodiment, the first side may be the left side and the second side may be the right side. The indicators 331 displayed in order may have priorities. In an embodiment, an indicator having a higher priority is positioned on the left, and an indicator having a lower priority is positioned on the right.

The indicators 331 provided on the first apparatus operation UI 300 will be described by way of example. Table 1 lists information that may be displayed as indicators 331 on the first apparatus operation UI 300 in an embodiment. The priority may increase in order of “Screen Occupying Device”->“Wi-Fi”->“Remote Control”->“Door Locked”->“Drying Preparation”->“Turbo Shot”->“Steam”->“Reservation”->“Wrinkle Prevention”->“Lock.”

TABLE 1

| Information indicated | | |
|---|---|---|
| by indicators | | |
| (Icon examples | | Reference |
| omitted) | Description of the state of the displayed indicator | numeral |
| Screen-occupying | Information on the device with the enabled | 331a |
| device | interface (visual indication of whether the enabled | |
| | interface is the first apparatus operation UI 300 or | |
| | the second apparatus operation UI 400) | |
| Wi-Fi | Wi-Fi connection status- Connected: indicated | 331b |
| | according to the connection strength | |
| | Indication of Disconnected | |
| | No icon displayed in the unregistered or no- | |
| | connection state | |
| Remote control | Indicated when remote control is in operation | 331c |
| Door Locked | Indicated when the door is locked after the start of | 331d |
| | the cycle | |
| Drying Preparation | Indicated when drying preparation is set | 331e |
| Turbo Shot | Indicated when turbo shot is set | 331f |
| Steam | Indicated when steam is set | 331g |
| Reservation | Indicated when reservation is set | 331h |
| Wrinkle Prevention | Indicated when wrinkle prevention is set | 331i |
| Lock | Indicated when the Lock function is set | 331j |

The indicators 431 provided on the second apparatus operation UI will be described by way of example. Table 2 lists information that may be displayed as the indicators 431 on the second apparatus operation UI in an embodiment. The priority may increase in order of “Screen Occupying Device”->“Wi-Fi”->“Remote Control”->“Door Locked”->“Steam”->“Turbo Shot”->“Ironing Reminder”->“Reservation.”

TABLE 2

| Information indicated | | |
|---|---|---|
| by indicators | | |
| (Icon examples | | Reference |
| omitted) | Description of the state of the displayed indicator | numeral |
| Screen-occupying | Information on the device with the enabled | 431a |
| device | interface (visual indication of whether the enabled | |
| | interface is the first apparatus operation UI 300 or | |
| | the second apparatus operation UI 400) | |
| Wi-Fi | Wi-Fi connection status- Connected: indicated | 431b |
| | according to the connection strength | |
| | Indication of Disconnected | |
| | No icon displayed in the unregistered or no- | |
| | connection state | |
| Remote control | Indicated when remote control is in operation | 431c |
| Door Locked | Indicated when the door is locked after the start of | 431d |
| | the cycle | |
| Steam | Indicated when steam is set | 431e |
| Ironing Reminder | Indicated when the ironing reminder is set | 431f |
| Reservation | Indicated when reservation is set | 431g |
| Lock | Indicated when the Lock function is set | 431h |

When each of the indicators 331 and 431 is generated and displayed, a motion effect may be applied to provide setting feedback. In an embodiment, the indicator 331a indicating the “screen-occupying device” provides intuitive visual information to the user as to which processing apparatus is currently being manipulated. In an embodiment, the indicator 331a indicating the “screen-occupying device” may be in the form of two rectangles stacked top to bottom. This represents the stacked form of the first processing apparatus 10 and the second processing apparatus 20. In the first apparatus operation UI 300, the lower rectangle may be colored. The lower rectangle may be colored in a first color. Although not shown in FIG. 9, in the second apparatus operation UI, the upper rectangle may be colored. The upper rectangle may be colored in a second color. The first color and the second color are different from each other. The difference in color allows the user to quickly recognize the controlled object visually.

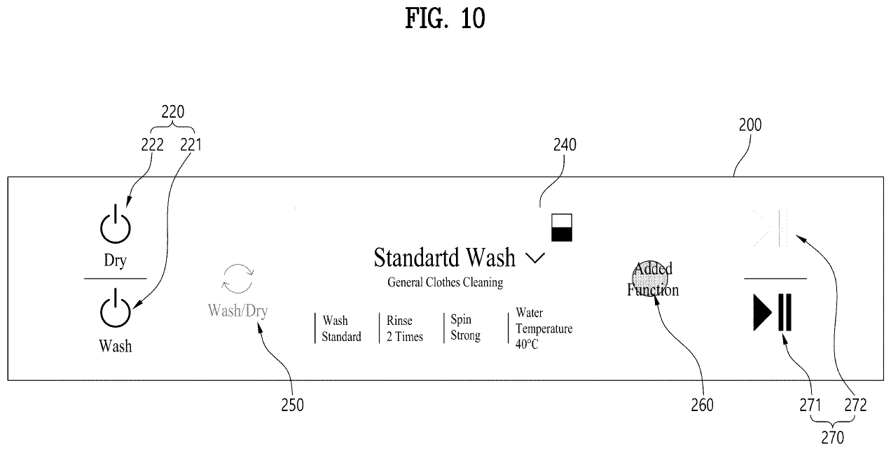

FIG. 10 illustrates a UI part according to one embodiment of the present disclosure, in which the first processing apparatus is powered on and the second processing apparatus is powered off, while a course selection page of the first apparatus operation UI 300 is output on the touch screen 240.

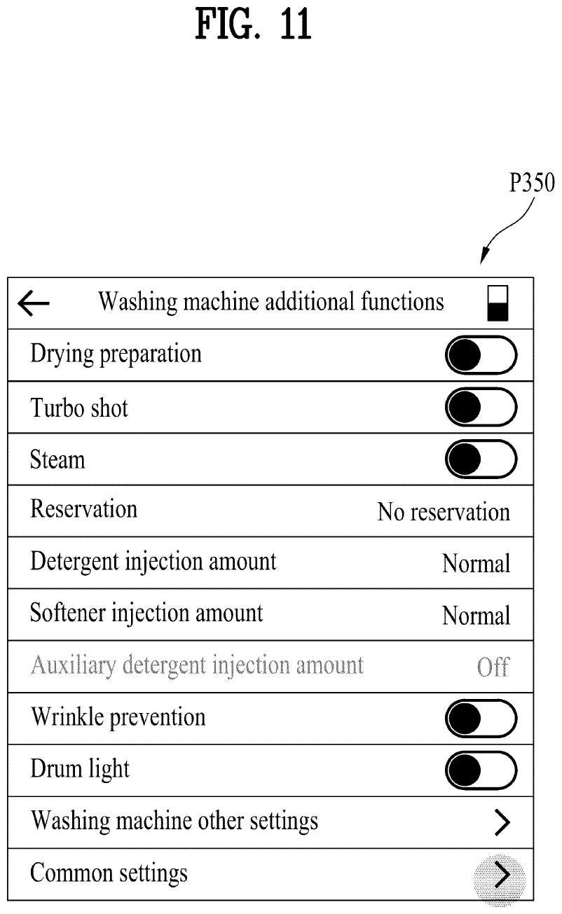

In the UI part 200, the additional function button 260 is indicated as enabled. Whether the additional function button 260 is enabled may be indicated by the emission status of light from a light emitting member positioned at the rear of the additional function button 260. When the additional function button 260 is enabled, the light emitting member emits light, causing the additional function button 260 to be illuminated. Upon receiving user input through the additional function button 260, the touch screen 240 may display an additional function page P350. The additional function corresponds to various options that the laundry treating apparatus may provide in performing a processing course. The additional function page P350 is described in more detail with reference to FIG. 11.

Even in the case where only the second processing apparatus 20 is running, indications similar to those in FIG. 10 may be applied. The touch screen 240 will display the second apparatus operation UI. The first start/pause button 271 will be indicated to be in a disabled state and the second start/pause button 272 will be indicated to be in an enabled state. The enabled state may be indicated by emission of light from the light emitting elements positioned behind each of the start/pause buttons 270. In an embodiment, the enabled state may be indicated when light is emitted and the disabled state may be indicated when the emission of light is off. A drying course may be provided instead of the wash course. When touch input is received through the additional function button 260 while the second apparatus operation UI is displayed on the touch screen 240, an additional function page is output on the touch screen 240, and the additional function page lists the additional functions of the second processing apparatus 20. The related drawings will be omitted.

FIG. 11 shows an additional function page P350 of the first processing apparatus 10. FIG. 11 illustrates a touch input to enter a “Common Settings” item among the items of the additional function.

Hereinafter, a description will be given with reference to FIG. 11. The additional function page P350 is an embodiment of the function setting page. The function setting page may display various settable functions and may receive. In an embodiment, the additional function page P350 may provide multiple settable additional functions. In the present disclosure, the functions settable on the additional function page P350 according to the embodiment are referred to as additional functions. The multiple additional functions may be provided as a list of items. The multiple additional functions provided on the additional function page P350 may be as many as not to be displayed all on one screen of the touch screen 240. On the additional function page P350, the entire items may be scanned through scrolling movements made by the user. For ease of illustration, the additional function page P350 is shown in its entirety according to one embodiment. The additional function page P350 may display an indicator indicating the “screen-occupying device.”

In an embodiment, the first processing apparatus 10 is a washing machine. In an embodiment, the washing machine may be provided with multiple additional functions. The multiple additional functions may be provided as a list of items. The additional functions may include, but are not limited to, a drying preparation function, a turbo shot function, a steam function, a reservation function, a detergent dosage setting function, a softener dosage setting function, a secondary detergent dosage setting function, an wrinkle prevention function, and a drum light function.

Additionally, additional functions which are less frequently used may be grouped in the washing machine miscellaneous settings.

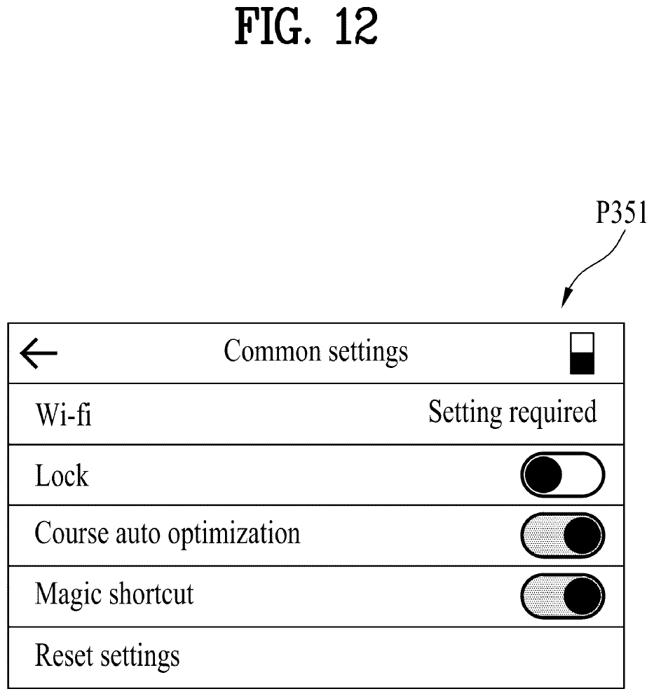

In an embodiment, additional functions that may be set in common for the first processing apparatus 10 and the second processing apparatus 20 may be grouped in the “Common Settings” item. In an embodiment, the non-settable items may be displayed darker than the other items (to be dimmed) to visually alert the user that they cannot be set. FIG. 11 illustrates a touch input to enter the “Common Settings” item. Upon entering the “Common Settings” item, the common settings page P351 shown in FIG. 12 may be output.

FIG. 12 shows a common settings page P351, which is a page that contains a group of additional functions that may be set in common for the first processing apparatus 10 and the second processing apparatus 20. Hereinafter, a description will be given with reference to FIG. 12.

The additional functions provided on the common settings page P351 may include, but are not limited to, Wi-Fi settings, locking, course auto-optimization, magic shortcut, and settings reset. The “Common Settings” item, which is an additional function provided on the common settings page P351, synchronizes the settings with the second processing apparatus 20. In an embodiment, for the setting values of the “Common Settings” item, the first processing apparatus 10 and the second processing apparatus 20 are synchronized with each other.

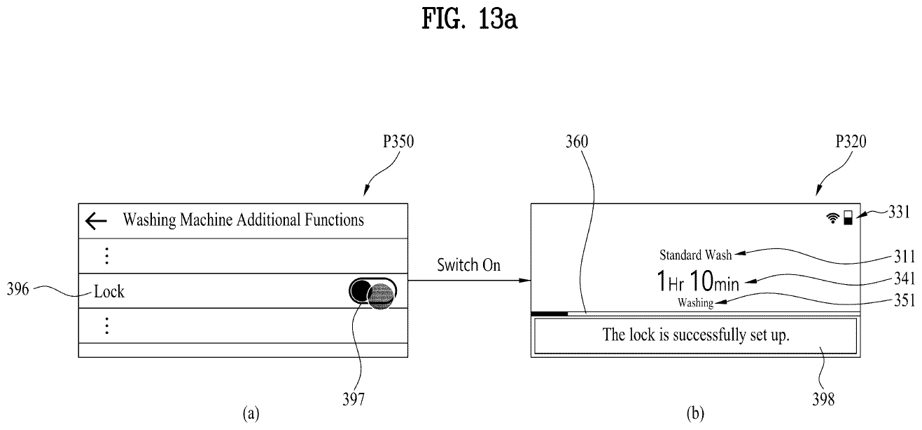

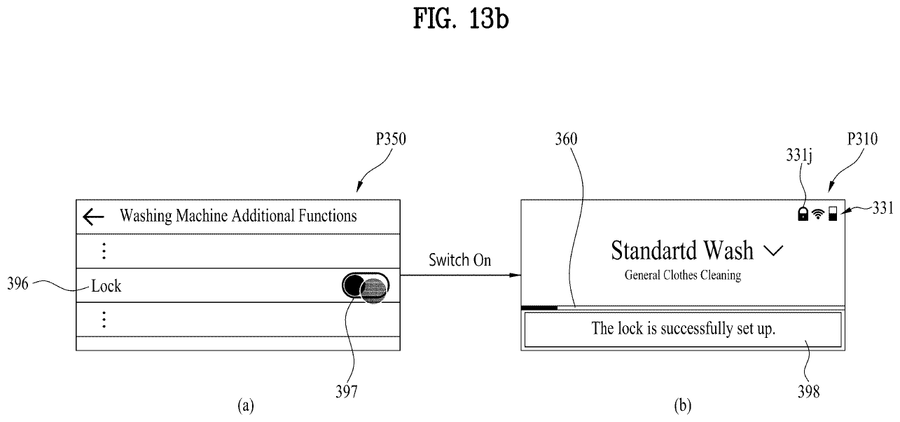

FIG. 13A illustrates a first embodiment and flow of setting a lock function among the additional functions. Hereinafter, a description will be given with reference to FIG. 13A.

The lock function is a function that prevents functions from being executed even if a user command is input to prevent misuse. The lock function is a function that locks the input through the UI part 200. When the lock function is enabled, any functions except for the command to disable the lock function are not executed even if input is received. Once the lock function is enabled, the lock function prevents user commands from being executed even when input through the touch screen 240, power button 220, switching button 250, additional function button 260, and start/pause button 270. The lock function may be set in the additional function page P350. The additional function page P350 displays a lock setting part 396 for enabling the lock function. The lock setting part 396 is provided with an On/Off switch 397. The On/Off switch 397 is displayed to occupy a portion of the area of the touch screen 240, and may be switched between On and Off through a touch input in the occupied area. The lock function may be set using the On/Off switch 397. In the embodiment, the lock function is disabled and the On/Off switch 397 is shown in the Off state. In an embodiment, the On/Off switch 397 may be switched between On and Off when the On/Off switch 397 is touched. The On/Off switch 397 in the Off state may be touched to switch to the On state and enable the lock function.

(b) is an image displayed on the touch screen 240 after the lock function is enabled. Once the lock function is set, the image displayed on the touch screen 240 reverts to the page displayed before entering the additional function. In an embodiment, the image displayed on the touch screen 240 prior to touching the additional function button 260 is a first page P320.

The first page P320 is output when a cycle is in progress. In an embodiment, the first page P320 displays the time 341 remaining until the processing is completed and multiple pieces of additional information related to the status of the first processing apparatus 10. In an embodiment, the first page P320 displays a course name 311, a remaining time 341, a status name 351 indicating a current status such as the current cycle name, a progress bar 360, an indicator 331, and an option display part 320. In some embodiments, a setting completion pop-up 398 may be output in the area where the option display part 320 is positioned, thereby hiding the option display part 320. The setting completion pop-up 398 provides a notification to the user that the lock setup is complete. The notification text of the setting completion pop-up 398 may be “The lock is successfully set up.”

In the portion where the indicator 331 is displayed, a lock indicator 331j may be further displayed to indicate that the lock function is set. The lock indicator 331j may be formed as an icon representing a lock indication.

The progress bar 360 is a means to visually indicate the progress of the clothing processing performed by the first processing apparatus 10. In an embodiment, the progress bar 360 may have a bar horizontal shape that extends across the touch screen 240 from side to side. The progress bar 360 indicates the progress of the clothing processing with the length of the colored portion of the bar shape. The progress bar 360 increases the colored portion of the bar as the processing progresses. In an embodiment, the color of the colored portion of the progress bar 360 displayed on the first apparatus operation UI 300 may be different from the color of the colored portion of the progress bar displayed on the second apparatus operation UI. In an embodiment, the color of the colored portion of the progress bar 360 displayed on the first apparatus operation UI 300 may be a first color. The color of the colored portion of the progress bar 360 displayed on the second apparatus operation UI may be a second color. The first and second colors are the same as the first and second colors of the colored portion of the indicator 331a indicating the “screen-occupying device,” or are at least colors perceived as the same by the user.

FIG. 13B shows a second embodiment and flow of setting a lock function among the additional functions. Hereinafter, a description will be given with reference to FIG. 13B.

In the figure, (a) illustrates setting a lock function on the additional function page P350. Regarding the setting of the lock function, reference may be made to (a) of FIG. 13A.

In the figure, (b) shows an image displayed on the touch screen 240 after the lock function is set. Once the lock function is set, the image displayed on the touch screen 240 reverts to the page prior to entering the additional function. In an embodiment, the image displayed on the touch screen 240 before touching the additional function button 260 is the course selection page P310. In an embodiment, the setting completion pop-up 398 may be output at the bottom of the course selection page P310. The setting completion pop-up 398 provides a notification to the user that the lock setup is complete. The notification text of the setting completion pop-up 398 may be “The lock is successfully set up.”

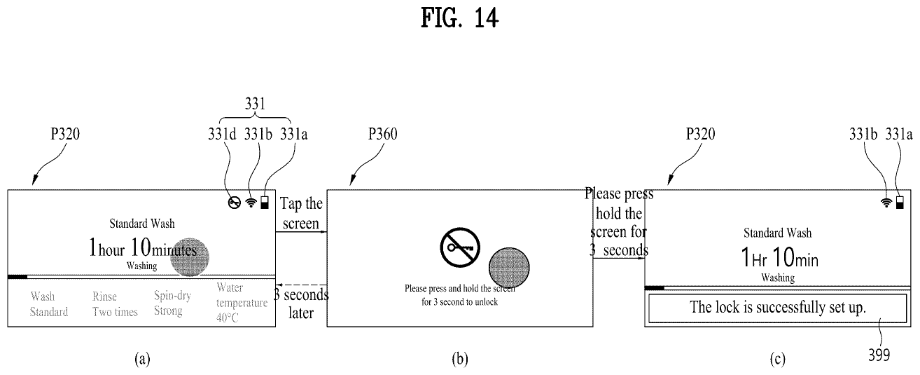

FIG. 14 illustrates an image displayed on the touch screen 240 when the lock is set and a flow for unlocking the lock the lock.

In the figure, (a) shows an image displayed on the touch screen 240 while a processing course of the first processing apparatus 10 is in progress with the lock function set. The first page P320 is displayed on the touch screen 240. Touching any portion of the touch screen 240 displays the lock guide page P360, as shown in (b). The lock guide page P360 is output when the action for unlocking is performed. In an embodiment, unlocking may be executed by holding a touch on the touch screen 240 for a set time or longer. In an embodiment, the lock guide page P360 is output when the touch screen 240 is touched for a shorter time than the touch time that must last for unlocking. In an embodiment, the lock guide page P360 is also displayed on the touch screen 240 when receiving user input through the input part 2002 of the UI part 200, such as the power button 220, the switch button 250, the additional function button 260, and the start/pause button 270.

In the figure, (b) illustrates the lock guide page P360. The lock guide page P360 displays an indication that the lock function is set. A method to unlock (disable) the lock is indicated on the lock guide page P360. In an embodiment, the lock may be unlocked by touching and holding any portion of the touch screen 240 for a set time or longer. In an embodiment, the set time may be 3 seconds. In an embodiment, a message such as “Please press and hold the screen for 3 seconds to unlock” may be provided on the lock guide page P360. Since the laundry treating apparatus is generally installed in a space exposed to moisture, there is a concern that the enabled lock function may be unintentionally disabled if the touch screen is unlocked by a short touch. The aforementioned concern may be reduced by applying a method in which the lock function is disabled only when a touch on the touch screen is held for a set time or longer, as in the embodiment of the present disclosure.

Flow from (b) to (a): When the set duration (e.g., 3 seconds) elapses without any input from the user after the lock guide page P360 is output, the first page P320 in the locked state may be output again.

Flow from (b) to (c): When the user presses any portion of the touch screen 240 for 3 seconds or longer, the lock is unlocked. When the lock is unlocked, an unlock completion pop-up 399 may be displayed. In an embodiment, the unlock completion pop-up 399 may be displayed at the bottom of the image provided by the touch screen 240. The unlock completion pop-up 399 provides a notification to the user that the lock has been unlocked. The notification text of the unlock completion pop-up 399 may be “Unlocked.”

While the present disclosure has been illustrated and described with reference to specific embodiments, it will be apparent to those of ordinary skill in the art that various modifications and variations can be made to the present disclosure without departing from the spirit or scope of the disclosure as defined by the appended claims.

1. A laundry treating apparatus, comprising:
a user interface (UI) part comprising:
a touch screen configured to receive a touch input and display an image; and
a button part provided in a different area from the touch screen to receive an input from a user,
wherein the laundry treating apparatus has a lock function to restrict inputs through the touch screen and the button part, and
wherein, based on the touch input on the touch screen being maintained for a set time or longer with the lock function in an enabled state, the lock function is disabled.

2. The laundry treating apparatus of claim 1, wherein, based on an input being received through the touch screen or the button part with the lock function enabled, the touch screen outputs the enabled state of the lock function.

3. The laundry treating apparatus of claim 1, wherein, based on an input being received through the touch screen or the button part with the lock function enabled, the touch screen outputs a method to disable the lock function.

4. The laundry treating apparatus of claim 1, wherein the touch screen outputs one of:
a first page indicating a processing course; and
a function setting page,
wherein the function setting page contains a lock setting part, the lock setting part being configured to receive a user command to enable the lock function.

5. The laundry treating apparatus of claim 4, wherein the lock setting part contains a switch configured to receive a user command to switch the lock function to the enabled state.

6. The laundry treating apparatus of claim 4, wherein, based on the lock function being enabled on the function setting page, the image on the touch screen switches from the function setting page to the first page.

7. A laundry treating apparatus, comprising:
a user interface (UI) part comprising:
a touch screen configured to receive a touch input and display an image; and
a button part provided in a different area from the touch screen to receive an input from a user,
wherein the laundry treating apparatus has a lock function to restrict inputs through the touch screen and the button part,
wherein the touch screen outputs one of:
a first page indicating a processing course; and
a function setting page,
wherein the function setting page contains a lock setting part, the lock setting part being configured to receive a user command to enable the lock function.

8. The laundry treating apparatus of claim 7, wherein the lock setting part contains a switch configured to receive a user command to switch the lock function to the enabled state.

9. The laundry treating apparatus of claim 7, wherein, based on the lock function being enabled on the function setting page, the image on the touch screen switches from the function setting page to the first page.

10. The laundry treating apparatus of claim 7, wherein, based on an input being received through the touch screen or the button part with the lock function enabled, the touch screen outputs the enabled state of the lock function.

11. The laundry treating apparatus of claim 7, wherein, based on an input being received through the touch screen or the button part with the lock function enabled, the touch screen outputs a method to disable the lock function.

12. The laundry treating apparatus of claim 1, further comprising:
a first processing apparatus having a first drum arranged therein to accommodate clothing;
a second processing apparatus having a second drum arranged therein to accommodate clothing; and
a control panel configured to control one or both of the first processing apparatus and the second processing apparatus, the control panel comprising the UI part,
wherein the touch screen outputs one of:
a first apparatus operation UI configured to operate the first processing apparatus; and
a second apparatus operation UI configured to operate the second processing apparatus,
wherein, based on a command to enable the lock function being input on one of the first apparatus operation UI and the second apparatus operation UI, the lock function is applied to the other one of the first apparatus operation UI and the second apparatus operation UI.

13. The laundry treating apparatus of claim 12, wherein:
the first processing apparatus comprises a first front panel arranged on a front side thereof; and
the second processing apparatus comprises a second front panel arranged on a front side thereof,
wherein the control panel is arranged between the first front panel and the second front panel.

14. The laundry treating apparatus of claim 13, wherein:
the first processing apparatus is a washing machine; and
the second processing apparatus is a dryer,
wherein the second processing apparatus is positioned on top of the first processing apparatus.
